(19) United States
(12) Patent Application Publication
(10) Pub. No.: US 2026/0267761 A1
(43) Pub. Date: Sep. 10, 2026

(54) Transient Simulation Waveform Storage Method and System, Device and Readable Medium

(71) Applicant: PRIMARIUS TECHNOLOGIES CO., LTD., Shanghai (CN)

(72) Inventors: Xiangkai WANG, Shanghai (CN); Yihui LI, Shanghai (CN); Jun FANG, Shanghai (CN)

(21) Appl. No.: 19/129,610

(22) PCT Filed: Mar. 14, 2023
(86) PCT No.: PCT/CN2023/077167

§ 371 Date: May 13, 2025

(30) Foreign Application Priority Data
Nov. 14, 2022 (CN) 202211417495.9

(51) Int. Cl. G06F 11/34

(52) U.S. Cl. CPC G06F 11/3428

(57) ABSTRACT

A transient simulation waveform storage method and system, a device and a readable medium. The method includes: selecting appropriate first waveform data values to serve as basic reference points; acquiring a benchmark slope, and inserting a plurality of benchmark data in a time sequence, to generate a benchmark data set; by means of comparing the value of the benchmark data with the first waveform data value, acquiring second waveform data that meets a preset storage condition; performing characterization processing on the second waveform data; and performing encoding and compression to realize the storage of a transient simulation waveform. By means of the technical solution, without affecting the waveform storage precision, the number of simulation waveform data points is decreased, and the amount of simulation waveform data is reduced, thereby improving the data compression rate, and increasing the simulation speed of the simulation waveform data in an integrated circuit.

### TECHNICAL FIELD

The present invention relates to the field of a chip development technology, and in particular to a high transient simulation waveform storage method and system, a device and a readable medium.

### BACKGROUND ART

When simulating circuits based on EDA (electronic design automation) simulation software, transient simulation waveform storage is a necessary part of integrated circuit simulation. In a laboratory, voltage or current fluctuations that may occur in the actual field are simulated to ensure that the product can work normally in an actual environment. It is necessary to store the specified signal waveform and view first waveform data to determine whether the integrated circuit is designed to meet the expected design requirements.

When simulating the circuits, with the development of very large-scale integrated circuits, the complexity of the integrated circuits is getting higher and higher, and more and more simulation waveform data needs to be stored. The storage of a large amount of simulation waveform data will take up a very large hard disk space. The single signal that may exist in the transient simulation waveform is a floating-point number. For simulation waveform data, a large amount of floating-point data not only occupies additional storage space but also greatly increases the time for writing and storing. The data is not easy to compress, resulting in the simulation speed becoming slower and slower as the amount of simulation waveform data increases.

Therefore, it is an urgent need to provide a more efficient transient simulation waveform storage method to reduce the storage space and time consumption.

### SUMMARY OF THE INVENTION

Based on the defects in the prior art, the present application proposes a transient simulation waveform storage method and system, a device and a readable medium, which specifically include:

In a first aspect of the present application, a transient simulation waveform storage method is provided, which specifically includes:
selecting two first waveform data in a first waveform data set as basic reference points, and acquiring waveform slopes corresponding to the basic reference points;
inserting a plurality of benchmark data using the waveform slopes as a benchmark slope to generate a benchmark data set, a value type of the benchmark data set being consistent with a value type of the first waveform data set;
detecting the first waveform data in the first waveform data set according to the benchmark data in the benchmark data set, saving the first waveform data that meets a preset storage condition as second waveform data, and updating the basic reference points according to the second waveform data;
performing characterization processing on the second waveform data to obtain pre-stored simulation waveform data; and
compressing the pre-stored simulation waveform data into a transient simulation waveform.

In a possible implementation of the above first aspect, selecting two first waveform data in a first waveform data set as basic reference points includes: selecting values of at least two first waveform data that meet preset benchmark waveform generation conditions as basic reference points.

In a possible implementation of the above first aspect, detecting the first waveform data in the first waveform data set successively according to the benchmark data in the benchmark data set and saving the first waveform data that meets a preset storage condition as second waveform data includes: successively calculating a value tolerance of the benchmark data and the first waveform data corresponding to the same time point in a time sequence, and screening the first waveform data that meets the preset storage condition as the second waveform data according to the value tolerance.

In a possible implementation of the above first aspect, screening the first waveform data that meets the preset storage condition as the second waveform data according to the value tolerance includes: successively selecting the first waveform data whose value tolerance between the benchmark data and the first waveform data corresponding to the same time point is greater than or equal to a preset tolerance threshold, and saving the first waveform data as the second waveform data.

In a possible implementation of the first aspect, updating the basic reference points includes:
acquiring second waveform data and a time point corresponding to the second waveform data; and
updating the basic reference points according to the second waveform data and the first waveform data at the next time point corresponding to the second waveform data.

In a possible implementation of the first aspect, performing characterization processing on the value of the second waveform data to obtain pre-stored simulation waveform data includes: performing discretization processing on the second waveform data, and saving the obtained discrete data as the pre-stored simulation waveform data.

In a possible implementation of the first aspect, compressing the pre-stored simulation waveform data to obtain the transient simulation waveform includes:
encoding discrete data based on an incremental encoding algorithm, and compressing the encoded data using a lossless compression algorithm to obtain the transient simulation waveform.

In a second aspect of the present application, a transient simulation waveform storage system is provided, which specifically includes:
a slope acquisition unit, used for selecting two first waveform data in a first waveform data set as basic reference points, and acquiring waveform slopes corresponding to the basic reference points;
a benchmark data generation unit, used for inserting a plurality of benchmark data using the waveform slopes as a benchmark slope to generate a benchmark data set, a value type of the benchmark data set being consistent with a value type of the first waveform data set;
a second waveform data acquisition unit, used for detecting the first waveform data in the first waveform data set according to the benchmark data in the benchmark data set. saving the first waveform data that meets a preset storage condition as second waveform data, and updating the basic reference points according to the second waveform data;
a characterization processing unit, used for performing characterization processing on the second waveform data to obtain pre-stored simulation waveform data; and
a data compression unit, used for compressing the pre-stored simulation waveform data into a transient simulation waveform.

In a third aspect of the present application, an electronic device is provided, which specifically includes:
a memory, used for storing a processing program; and
a processor that implements the aforementioned transient simulation waveform storage method when executing the processing program.

In a fourth aspect of the present application, a readable storage medium is provided, wherein a processing program is stored on the readable storage medium, and when the processing program is executed by a processor, the transient simulation waveform storage method as described above is implemented.

Compared with the prior art, the present application has the following beneficial effects: Through the technical solution proposed in the present application, the basic reference points can be generated according to the value of the first waveform data, and the benchmark data set can be generated based on the basic reference points as a basis for screening the first waveform data. The first waveform data that meets the preset storage condition is saved as the second waveform data, thereby eliminating a large amount of floating-point data existing in the first waveform data, that is, the first waveform data that does not meet the preset storage condition. Without affecting the waveform storage accuracy, the number of simulation waveform data points is decreased, and the amount of simulation waveform data is reduced, thereby improving the data compression rate, and increasing the simulation speed of the simulation waveform data in an integrated circuit.

### BRIEF DESCRIPTION OF THE DRAWINGS

By reading the detailed description of the non-limiting embodiments with reference to the following drawings, other features, purposes and advantages of the present invention will become more apparent.

FIG. 1 is a schematic diagram illustrating a process of a transient simulation waveform storage method according to an embodiment of the present application;

FIG. 2 is a schematic diagram illustrating a second waveform data acquisition method according to an embodiment of the present application;

FIG. 3 is a schematic diagram illustrating another second waveform data acquisition method according to an embodiment of the present application;

FIG. 4 is a block diagram of a transient simulation waveform storage system according to an embodiment of the present application.

### DETAILED DESCRIPTION OF THE INVENTION

The present invention is described in detail below in combination with specific embodiments. The following embodiments will assist those skilled in the art to further understand the present invention, but are not intended to limit the present invention in any way. It should be noted that, for those ordinary skilled in the art, several changes and improvements can also be made without departing from the concept of the present invention. These all belong to the protection scope of the present invention.

The terms “include” and its variations used herein indicate open inclusion, i.e., “include but not limited to”. Unless specifically stated, the term “or” indicates “and/or”. The term “based on” indicates “at least partially based on”. The terms “one exemplary embodiment” and “one embodiment” indicate “at least one exemplary embodiment”. The term “another embodiment” indicates “at least one other embodiment”. The terms “first”, “second”, etc., can refer to different or identical objects. Other explicit and implied definitions may also be included below.

In order to solve the problems in the prior art that a large amount of floating-point data in an online shopping process occupies an additional storage space and the time for writing and storing also increases greatly, and second waveform data is not easy to compress, resulting in the simulation speed becoming slower and slower as first waveform data increases, the present application proposes a transient simulation waveform storage method and system, a device and a readable medium. Through the transient simulation waveform storage method, a benchmark data set is generated based on a basic reference point as a basis for screening the first waveform data, and the first waveform data that meets a preset storage condition is saved as the second waveform data, thereby eliminating a large amount of floating-point data existing in the first waveform data, that is, the first waveform data that does not meet the preset storage condition, decreasing the number of second waveform data points, reducing the amount of the first waveform data, improving the data compression rate, and increasing the simulation speed of the second waveform data in the integrated circuit.

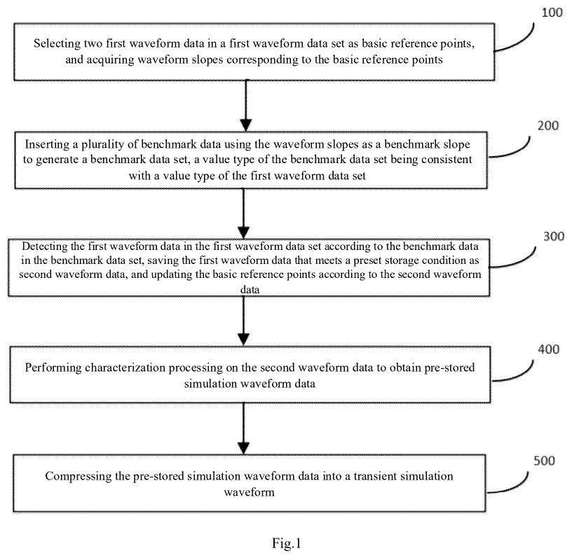

Specifically, as shown in FIG. 1, a schematic diagram illustrating a process of a transient simulation waveform storage method is shown according to an embodiment of the present application, which specifically includes:

Step 100: selecting two first waveform data in a first waveform data set as basic reference points, and acquiring waveform slopes corresponding to the basic reference points. It can be understood that the first waveform data stored in the transient simulation waveform may correspond to voltage data or current data, and the first waveform data set includes a plurality of first waveform data. Some values of the first waveform data appear to be greatly offset in the entire data set. This part of the data obviously has no reference value and meaning in the instantaneous waveform storage, Therefore, it is necessary to judge the first waveform data at the current time point before the instantaneous waveform storage. The first waveform data that can be ignored may be eliminated by an interpolation data method to ensure that the first waveform data is reduced without affecting the waveform accuracy.

In the above step 100, values of at least two first waveform data that meet preset benchmark waveform generation conditions are selected as basic reference points. It can be understood that the acquired first waveform data is generated based on a certain preset time. Within the preset time period, the values of the two first waveform data adjacent to the time point at which the first waveform data is generated in the first waveform data set may be selected as the basic reference points. The values of the first waveform data corresponding to two appropriate adjacent time points may be selected as reference points to obtain the slope between the two value points, so as to serve as the basis for forming interpolation data.

In some embodiments of the present application, the present invention can select the values of the first waveform data at the appropriate time points and appropriate number of position points as the basis for calculating the waveform slope according to actual conditions.

Step 200: inserting a plurality of benchmark data using the waveform slopes as a benchmark slope to generate a benchmark data set, a value type of the benchmark data set being consistent with a value type of the first waveform data set. It can be understood that the waveform slope obtained by the value calculation of the first waveform data of the adjacent point is used as the benchmark slope formed by the interpolation data, and is extended along a time direction to form an interpolation waveform extending along the time sequence, so as to obtain the interpolation data of other time points in the time sequence as the benchmark data, and form a benchmark data set with the benchmark data, and then obtain the value of the benchmark data at the time point corresponding to the first waveform data. The value of the first waveform data may be a current value or a voltage value in a simulation test, and at this time, the value of the benchmark data set needs to be consistent with the value of the first waveform data, so as to accurately screen the first waveform data according to the benchmark data.

Step 300: detecting the first waveform data in the first waveform data set according to the benchmark data in the benchmark data set, saving the first waveform data that meets a preset storage condition as second waveform data, and updating the basic reference points according to the second waveform data. It can be understood that a certain difference may exist between the values of the benchmark data and the first waveform data at the same time point, and the size of the difference is correlated with the selection of the benchmark slope, that is, the basic reference point. When screening whether the first waveform data meets the preset storage condition, it is necessary to compare the benchmark data generated based on the same time and the appropriate benchmark slope. In some embodiments of the present application, the value generation of the benchmark data corresponding to different time points may be based on different benchmark slopes. In the above step 300, detecting the first waveform data in the first waveform data set successively according to the benchmark data in the benchmark data set and saving the first waveform data that meets a preset storage condition as second waveform data includes: successively calculating a value tolerance of the benchmark data and the first waveform data corresponding to the same time point in a time sequence, screening the first waveform data that meets the preset storage condition according to the value tolerance, and saving the first waveform data as the second waveform data. It can be understood that the value tolerance between the benchmark data formed by the selected basic data point and the value of the first waveform data corresponding to the same time point is used as the basis for whether the first waveform data can be retained, so the value of the benchmark waveform is selected and the value tolerance is used as the basis for the preset storage condition.

In some embodiments of the present application, the value tolerance may include an absolute tolerance or a relative tolerance, and those skilled in the art may select the tolerance based on the specific first waveform data, which is not limited here.

Further, screening the first waveform data that meets the preset storage condition as the second waveform data according to the value tolerance includes:
successively selecting the first waveform data whose value tolerance between the benchmark data and the first waveform data corresponding to the same time point is greater than or equal to a preset tolerance threshold, and saving the first waveform data as the second waveform data. It can be understood that when the value tolerance between the benchmark data and the first waveform data corresponding to the same time point is too small, eliminating the redundant data points of this part would not have any effect on the storage of the second waveform data.

In the above step 300, updating the basic reference points includes: obtaining the time point corresponding to the second waveform data; and updating the basic reference points according to the second waveform data and the first waveform data at the next time point corresponding to the second waveform data. It can be understood that if the first waveform data at the current time point can be used as the second waveform data for the next step of pre-storage, at this time, in order to ensure the accuracy of the first waveform data storage, it is necessary to update the benchmark slope and select new benchmark data to compare with the first waveform data to achieve more accurate waveform simulation data storage. Therefore, at this time, the second waveform data and the first waveform data at the next time point corresponding to the second waveform data are selected to update the basic reference points, so as to generate updated benchmark data for screening the first waveform data.

Regarding the acquisition of the second waveform data by screening the first waveform data based on the basic reference points and the updated basic reference points, the detailed description will be made below:

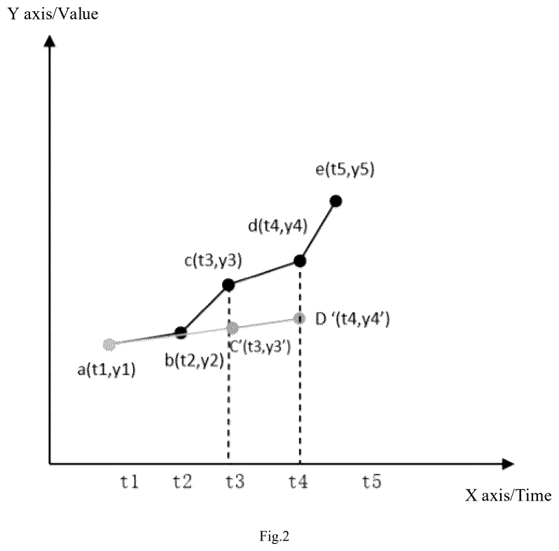

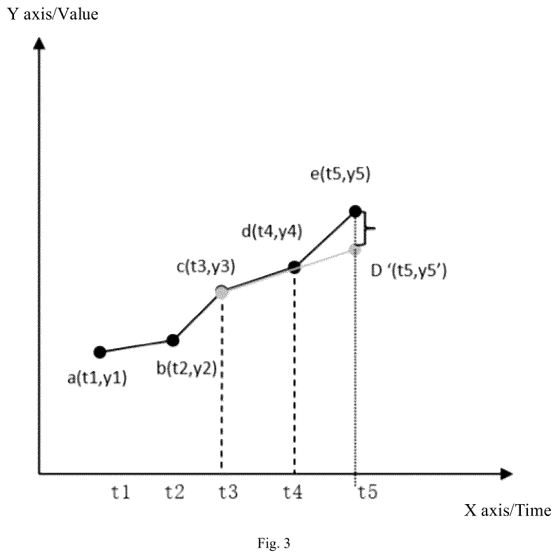

Specifically, as shown in FIGS. 2 and 3, a schematic diagram illustrating a second waveform data acquisition method is shown according to an embodiment of the present application.

For example, as shown in FIG. 2, two first waveform data value points adjacent to each other in the time point are selected, a(t1, y1) and b(t2, y2) are selected as basic reference points, the waveform slope is obtained as the benchmark slope according to the coordinate points of a and b, an extended extrapolated waveform based on the benchmark slope is used as the benchmark first waveform data, the values of the benchmark first waveform data at a time t3 and the first waveform data of the first waveform data c(t3, y3) are selected for the value tolerance judgment, the y value distance between a point c c(t3, y3) and a point c'c(t3′, y3′) is calculated, the tolerance threshold is preset to tol, and the comparison result of fabs(y3−y3′) and tol can be judged: If fabs(y3−y3′) is less than or equal to tol, it is considered that the value of the first waveform data at a point c(t3, y3) at this time has a too small value tolerance with the aforementioned a(t1, y1) and b(t2, y2). Deleting the value of c(t3, y3) would not affect the compressed storage of the second waveform data, nor affect the final verification of the integrated circuit. Therefore, the point c(t3, y3) is deleted, and the data at a point c is not included in the storage of the second waveform data.

Further, at this time, since no new second waveform data is introduced, the basic reference points would not be updated. The value tolerance of d(t4, y4) and d′(t4, y4′) corresponding to the previous benchmark slope is still judged to determine whether to save d(t4, y4) as the second waveform data for pre-storage.

For example, as shown in FIG. 3, two first waveform data value points adjacent to each other in the time point are selected, a(t1, y1) and b(t2, y2) are selected as basic reference points, the waveform slope is obtained as the benchmark slope according to the coordinate points of a and b, an extended extrapolated waveform based on the benchmark slope is used as the benchmark first waveform data, the values of the benchmark first waveform data at a time t3 and the first waveform data of the first waveform data c(t3, y3) are selected for the value tolerance judgment, the y value distance between a point c c(t3, y3) and a point c′c(t3′, y3′) is calculated, the tolerance threshold is preset to tol, and the comparison result of fabs(y3−y3′) and tol can be judged: If fabs(y3−y3′) is greater than tol, it is considered that the value of the first waveform data at a point c(t3, y3) at this time has a large enough value tolerance with the aforementioned a(t1, y1) and b(t2, y2). Deleting the value of c(t3, y3) would affect the compressed storage of the second waveform data, and thus affect the final verification of the integrated circuit. Therefore, the point c(t3, y3) is not deleted, and the data at the point c is included in the storage of the second waveform data. c(t3, y3) is used as the second waveform data for pre-storage, and based on c(t3, y3) and d(t4, y4) as new basic reference points, the benchmark slope is updated, and then new benchmark data is acquired to further screen the first waveform data of e(t5, y5).

Further, the final second waveform data is acquired by successively screening the first waveform data in the above embodiment.

Step 400: performing characterization processing on the second waveform data to obtain pre-stored simulation waveform data. It can be understood that after the second waveform data is segmented as continuous data, the differences between observation points in the same segment disappear, and while retaining the curve characteristics of the data, the discretely processed waveform data is given corresponding values and generated as the pre-stored simulation waveform data to obtain the next step of encoding and compression.

In the above step 400, the second waveform data is subject to discretization processing, and the discrete data is acquired and saved as pre-stored simulation waveform data. It can be understood that data discretization refers to segmenting the continuous data into a discrete interval, which essentially realizes mapping points with large intervals to adjacent array elements, thereby reducing the demand for space and the amount of calculation. The goal of discretization is to convert continuous problems into discrete problems that can be processed by computers.

For example, the waveform value y21 of the second waveform is selected and multiplied by a certain amplification coefficient x, and the result is rounded to obtain the final result y21′. The same or similar rounding operation may also be performed on other waveform values. The rounded waveform values are saved as the discrete data in sequence, and the discretized waveform result is finally obtained and saved as the pre-stored simulation waveform data.

Wherein the amplification coefficient x may be set to a fixed value according to the value requirement of y21′, and is not limited here.

In some embodiments of the present application, the discretization processing may include segmentation principles based on equal distance, equal frequency or optimization methods such as clustering division, equal width division, equal frequency division, information entropy-based methods, to perform discretization processing on the second waveform data. Those skilled in the art can also select a suitable discretization data processing method based on the data characteristics of the second waveform, which is not limited here.

Step 500: compressing the pre-stored simulation waveform data into a transient simulation waveform. It can be understood that the second waveform data subject to the discretization processing may further save a storage space through an efficient compression encoding algorithm.

In the above step 500, the discrete data is encoded based on a Delta Encoding algorithm, and the encoded data is compressed using a lossless compression algorithm to obtain the transient simulation waveform. The compression of the waveform data may generally be achieved by changing the waveform representation method, so compression and encoding are inseparable. The efficient compression encoding algorithm includes at least one of the following: a Run Length Encoding algorithm and the Delta Encoding algorithm. Compression encoding may reduce disk storage space. Since the data type is the same as the simulation waveform data, the efficient compression encoding can be used to further save the storage space, for example, the lossless compression algorithm achieves compression and storage of the transient simulation waveform.

For example, in order to achieve the Delta Encoding, the first value y20 of the second waveform can be selected as a basic value, and the subsequent waveform value y22 can be selected as a change value, Δy=y20−y22, and then the value of y20 is replaced by Δy. Similarly, all waveform values which are not the basic values can be treated in the same or similar manner to finally achieve the Delta Encoding.

In some embodiments of the present application, lossless compression may be implemented using a zip compression algorithm, for example, all points of the second waveform are compressed using the zip compression algorithm to complete the lossless compression.

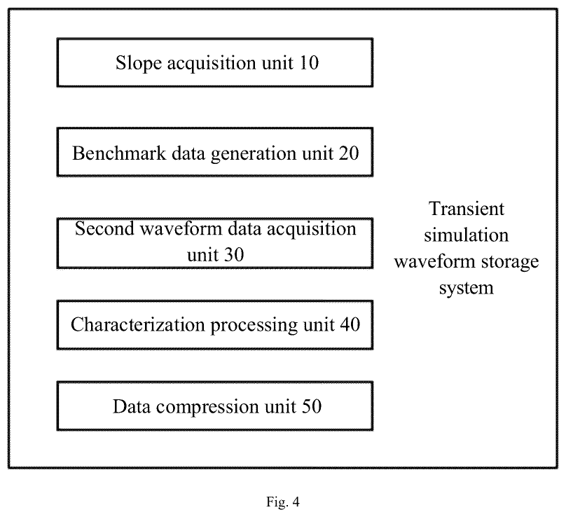

As shown in FIG. 4, a block diagram of a transient simulation waveform storage system is shown according to an embodiment of the present application, which specifically includes:
a slope acquisition unit 10, used for selecting two first waveform data in a first waveform data set as basic reference points, and acquiring waveform slopes corresponding to the basic reference points;
a benchmark data generation unit 20, used for inserting a plurality of benchmark data using the waveform slopes as a benchmark slope to generate a benchmark data set, a value type of the benchmark data set being consistent with a value type of the first waveform data set;
a second waveform data acquisition unit 30, used for detecting the first waveform data in the first waveform data set according to the benchmark data in the benchmark data set, saving the first waveform data that meets a preset storage condition as second waveform data, and updating the basic reference points according to the second waveform data;
a characterization processing unit 40, used for performing characterization processing on the second waveform data to obtain pre-stored simulation waveform data; and a data compression unit 50, used for compressing the pre-stored simulation waveform data into a transient simulation waveform.

It can be understood that each functional module in the above-mentioned transient simulation waveform storage system executes the same step process as the transient simulation waveform storage method in the aforementioned embodiment, and no repeated description is made here.

In some embodiments of the present application, an electronic device is further provided. The electronic device includes a memory and a processor, wherein the memory is used for storing a processing program, and the processor executes the processing program according to instructions. When the processor executes the processing program, the transient simulation waveform storage method in the aforementioned embodiment is implemented.

In some embodiments of the present application, a readable storage medium is further provided, which may be a non-volatile readable storage medium or a volatile readable storage medium. The readable storage medium stores instructions, which, when executed on a computer, cause the electronic device including the readable storage medium to execute the aforementioned transient simulation waveform storage method. Various aspects of the present disclosure are described herein with reference to the flow chart and/or the block diagram of the method, the device (system) and a computer program product according to the embodiments of the present disclosure. It should be understood that each box in the flow chart and/or the block diagram and the combination of the boxes in the flow chart and/or the block diagram can be implemented by computer-readable program instructions.

The computer-readable program instructions may be provided to a processing unit of a general-purpose computer, a special-purpose computer, or other programmable data processing apparatuses, thereby producing a machine, so that when these instructions are executed by the processing unit of the computer or other programmable data processing apparatuses, an apparatus that implements the functions/actions specified in one or more boxes in the flow chart and/or the block diagram is generated. The computer-readable program instructions may also be stored in a computer-readable storage medium, and enable the computer, the programmable data processing apparatus, and/or other devices to work in a specific manner, so that the computer-readable medium storing the instructions includes a manufactured product, which includes instructions for implementing various aspects of the functions/actions specified in one or more boxes in the flow chart and/or the block diagram.

The computer-readable program instructions may also be loaded onto the computer, other programmable data processing apparatuses, or other devices so that a series of operating steps are performed on the computer, other programmable data processing apparatuses, or other devices to produce a computer-implemented process, thereby enabling the instructions executed on the computer, other programmable data processing apparatuses, or other devices to implement the functions/actions specified in one or more boxes in the flow chart and/or the block diagram.

Flow charts and block diagrams in the drawings show realizable architectures functions and operation of the system, the method and the computer program product according to multiple embodiments of the present disclosure. In this regard, each block in the flow charts or block diagrams can represent a part of a module, a program segment or instructions; and the part of the module, the program segment or the instructions includes one or more executable instructions for realizing specified logical functions. In some alternative implementations, the functions indicated in the blocks may also occur in a sequence different from that indicated in the drawings. For example, two continuous blocks can actually be executed essentially concurrently, and sometimes can also be executed in reverse order, depending on the involved functions. It should also be noted that each block in the block diagrams and/or flow charts and combinations of the blocks in the block diagrams and/or flow charts can be realized by a hardware-based system specially used for executing specific functions or actions or realized by combinations of special hardware and computer instructions.

The embodiments of the present disclosure have been described above. The above embodiments are exemplary but not exhaustive, and not for limiting the embodiments disclosed herein. Many modifications and changes are apparent to those skilled in the art without departing from the scope and spirit of the embodiments described in the present disclosure. The terms used herein are selected to best explain the principle and practical application of each embodiment, to improve the technology in the market, or to enable others skilled in the art to understand each embodiment disclosed herein.

1. A transient simulation waveform storage method, wherein the method comprises:
selecting two first waveform data in a first waveform data set as basic reference points, and acquiring waveform slopes corresponding to the basic reference points;
inserting a plurality of benchmark data using the waveform slopes as a benchmark slope to generate a benchmark data set, a value type of the benchmark data set being consistent with a value type of the first waveform data set;
detecting the first waveform data in the first waveform data set according to the benchmark data in the benchmark data set, saving the first waveform data that meets a preset storage condition as second waveform data, and updating the basic reference points according to the second waveform data;
performing characterization processing on the second waveform data to obtain pre-stored simulation waveform data; and
compressing the pre-stored simulation waveform data into a transient simulation waveform.

2. The transient simulation waveform storage method according to claim 1, wherein the selecting two first waveform data in a first waveform data set as basic reference points comprises: selecting values of at least two first waveform data that meet preset benchmark waveform generation conditions as basic reference points.

3. The transient simulation waveform storage method according to claim 1, wherein the detecting the first waveform data in the first waveform data set successively according to the benchmark data in the benchmark data set and saving the first waveform data that meets a preset storage condition as second waveform data comprises:
successively calculating a value tolerance of the benchmark data and the first waveform data corresponding to the same time point in a time sequence, and screening the first waveform data that meets the preset storage condition as the second waveform data according to the value tolerance.

4. The transient simulation waveform storage method according to claim 3, wherein the screening the first waveform data that meets the preset storage condition as the second waveform data according to the value tolerance comprises:
successively selecting the first waveform data whose value tolerance between the benchmark data and the first waveform data corresponding to the same time point is greater than or equal to a preset tolerance threshold, and saving the first waveform data as the second waveform data.

5. The transient simulation waveform storage method according to claim 1, wherein the updating the basic reference points comprises:
acquiring the second waveform data and a time point corresponding to the second waveform data; and
updating the basic reference points according to the second waveform data and the first waveform data at a next time point corresponding to the second waveform data.

6. The transient simulation waveform storage method according to claim 1, wherein the performing characterization processing on the value of the second waveform data to obtain pre-stored simulation waveform data comprises:
performing discretization processing on the second waveform data, and saving the obtained discrete data as the pre-stored simulation waveform data.

7. The transient simulation waveform storage method according to claim 1, wherein the compressing the pre-stored simulation waveform data to obtain the transient simulation waveform comprises:
encoding discrete data based on an incremental encoding algorithm, and compressing the encoded data using a lossless compression algorithm to obtain the transient simulation waveform.

8. A transient simulation waveform storage system, wherein the system comprises:
a slope acquisition unit, used for selecting two first waveform data in a first waveform data set as basic reference points, and acquiring waveform slopes corresponding to the basic reference points;
a benchmark data generation unit, used for inserting a plurality of benchmark data using the waveform slopes as a benchmark slope to generate a benchmark data set, a value type of the benchmark data set being consistent with a value type of the first waveform data set;
a second waveform data acquisition unit, used for detecting the first waveform data in the first waveform data set according to the benchmark data in the benchmark data set, saving the first waveform data that meets a preset storage condition as second waveform data, and updating the basic reference points according to the second waveform data;
a characterization processing unit, used for performing characterization processing on the second waveform data to obtain pre-stored simulation waveform data; and
a data compression unit, used for compressing the pre-stored simulation waveform data into a transient simulation waveform.

9. An electronic device, comprising:
a memory, used for storing a processing program; and
a processor that implements the transient simulation waveform storage method according to claim 1 when executing the processing program.

10. A readable storage medium, wherein a processing program is stored on the readable storage medium, and when the processing program is executed by a processor, the transient simulation waveform storage method according to claim 1 is implemented.
